(19) United States
(12) Patent Application Publication
(10) Pub. No.: US 2019/0023553 A1
(43) Pub. Date: Jan. 24, 2019

(54) WATER DRINKING DEVICE AND WATER OUTLET DETECTION METHOD THEREOF

(71) Applicants: FOSHAN SHUNDE MIDEA WATER DISPENSER MFG. CO. LTD., Foshan (CN); MIDEA GROUP CO., LTD., Foshan (CN)

(72) Inventors: Caixia WANG, Foshan (CN); Xiaobai Yin, Foshan (CN); Feng Feng, Foshan (CN)

(21) Appl. No.: 16/140,254

(22) Filed: Sep. 24, 2018

Related U.S. Application Data
(63) Continuation of application No. PCT/CN2016/113789, filed on Dec. 30, 2016.

(30) Foreign Application Priority Data
Mar. 24, 2016 (CN) 201610179050.X

(51) Int. Cl. B67D 1/08; A47J 31/52

(52) U.S. Cl. CPC B67D 1/0884; B67D 2210/00104; A47J 31/5253

(57) ABSTRACT

A water drinking apparatus comprises a water cooling device and a temperature detector. The water cooling device has access to data corresponding to a plurality of temperature points within a water temperature range. After detecting, using the temperature detector and in real time, a water temperature of the cold water prepared by the water cooling device, the water drinking apparatus obtains actual data corresponding to each temperature point according to the water temperature of the cold water and determines whether the water drinking apparatus is in a water discharging state according to the data corresponding to the plurality of temperature points within the water temperature range, and the actual data corresponding to each temperature point according to the water temperature of the cold water.

### RELATED APPLICATIONS

This application is a continuation application of PCT Patent Application No. PCT/CN2016/113789, entitled “WATER DRINKING DEVICE AND WATER OUTLET DETECTION METHOD THEREOF” filed on Dec. 30, 2016, which claims priority to Chinese Patent Application No. 201610179050.X, filed with the Chinese Patent Office on Mar. 24, 2016, and entitled “WATER DRINKING DEVICE AND WATER OUTLET DETECTION METHOD THEREOF”, all of which are incorporated herein by reference in their entirety.

### TECHNICAL FIELD

The present disclosure relates to the field of an electrical appliance technology, and more particularly to a method for detecting water discharge of a water drinking apparatus and a water drinking apparatus applying such a method for detecting water discharge.

### BACKGROUND

Temperature of cooled water of a relevant water drinking apparatus will be increased the cold water after the cooled water is taken by a user, and the amount of cooled water that the user can drink is decreased. In order to ensure that the cooled water output is large enough, it is necessary to determine a water discharging state of the water drinking apparatus. In the related art, the cooled water discharge of the water drinking apparatus is usually controlled by a solenoid valve, and the water discharging state of the water drinking apparatus is determined according to a state of the solenoid valve.

However, disadvantages of a complex structure and high cost of the water drinking apparatus exist due to an increase of the number of solenoid valves in the related art, thus still requiring improvements.

### SUMMARY

The present disclosure seeks to solve at least one of the problems that exist in the related art to at least some extent. Accordingly, an object of the present disclosure is to provide a method for detecting water discharge of a water drinking apparatus. Such a method may be applied to determine a water discharging state of the water drinking apparatus without solenoid valve.

Another object of the present disclosure is to provide a water drinking apparatus.

In order to achieve above objects, embodiments of an aspect of the present disclosure provide a method for detecting water discharge of a water drinking apparatus, in which the water drinking apparatus includes a water cooling device and the method includes: acquiring a water temperature range of cooled water of the water cooling device, and acquiring a plurality of temperature points according to the water temperature range; acquiring a rising reference time, a falling reference time, a rising reference adjustment value, and a falling reference adjustment value of each temperature point; detecting a water temperature of the cooled water of the water cooling device in real time, and acquiring an actual rising time and an actual falling time of each temperature point according to the water temperature of the cooled water of the water cooling device; determining whether the water drinking apparatus is in a water discharging state according to the rising reference time, the falling reference time, the rising reference adjustment value, and the falling reference adjustment value of each temperature point, and the actual rising time and the actual falling time of each temperature point.

With the method for detecting water discharge of a water drinking apparatus provided by embodiments of the present disclosure, the water temperature of the cooled water of the water cooling device is detected in real time, and the actual rising time and the actual falling time of each temperature point are acquired according to the water temperature of the cooled water of the water cooling device, it is determined whether the water drinking apparatus is in a water discharging state according to the rising reference time, the falling reference time, the rising reference adjustment value, and the falling reference adjustment value of each temperature point, and the actual rising time and the actual falling time of each temperature point. Therefore, the method may be applied to determine the water discharging state of the water drinking apparatus without solenoid valve, thus decreasing the production cost of the water drinking apparatus and simplifying the structure of the water drinking apparatus.

In an embodiment of the present disclosure, determining whether the water drinking apparatus is in a water discharging state according to the rising reference time, the falling reference time, the rising reference adjustment value, and the falling reference adjustment value of each temperature point, and the actual rising time and the actual falling time of each temperature point includes: determining whether an actual falling time of any temperature point is greater than a first preset multiple of a sum of a falling reference time and a falling reference adjustment value of the temperature point; if yes, determining that the water drinking apparatus is in the water discharging state.

In an embodiment of the present disclosure, determining whether the water drinking apparatus is in a water discharging state according to the rising reference time, the falling reference time, the rising reference adjustment value, and the falling reference adjustment value of each temperature point, and the actual rising time and the actual falling time of each temperature point further includes: determining whether an actual falling time of each of three consecutive temperature points is greater than a sum of a falling reference time and a falling reference adjustment value of the each of the three consecutive temperature points; if yes, determining that the water drinking apparatus is in the water discharging state.

In an embodiment of the present disclosure, determining whether the water drinking apparatus is in a water discharging state according to the rising reference time, the falling reference time, the rising reference adjustment value, and the falling reference adjustment value of each temperature point, and the actual rising time and the actual falling time of each temperature point further includes: determining whether an actual rising time of any temperature point is smaller than a second preset multiple of a difference between a rising reference time and a rising reference adjustment value of the temperature point; if yes, determining that the water drinking apparatus is in the water discharging state.

In an embodiment of the present disclosure, determining whether the water drinking apparatus is in a water discharging state according to the rising reference time, the falling reference time, the rising reference adjustment value, and the falling reference adjustment value of each temperature point, and the actual rising time and the actual falling time of each temperature point further includes: determining whether an actual rising time of each of three consecutive temperature points is smaller than a difference between a rising reference time and a rising reference adjustment value of the each of the three consecutive temperature points; if yes, determining that the water drinking apparatus is in the water discharging state.

In an embodiment of the present disclosure, it is determined that the water drinking apparatus is in the water discharging state when the water temperature of the cooled water of the water cooling device is in a rising state and is increased by jump.

In order to achieve above objects, embodiments of another aspect of the present disclosure provide a water drinking apparatus, including: a water cooling device, configured to cool water; a temperature detector, configured to detect a water temperature of cooled water of the water cooling device; a control module, configured to acquire a water temperature range of the cooled water of the water cooling device, and acquire a plurality of temperature points according to the water temperature range and acquire a rising reference time, a falling reference time, a rising reference adjustment value, and a falling reference adjustment value of each temperature point, in which during operation of the water cooling device, the control module is further configured to: acquire an actual rising time and an actual falling time of each temperature point according to the water temperature of the cooled water of the water cooling device; determine whether the water drinking apparatus is in a water discharging state according to the rising reference time, the falling reference time, the rising reference adjustment value and the falling reference adjustment value of each temperature point, and the actual rising time and the actual falling time of each temperature point.

With the water drinking apparatus provided by embodiments of the present disclosure, the water temperature of the cooled water of the water cooling device is detected in real time, and the actual rising time and the actual falling time of each temperature point are acquired according to the water temperature of the cooled water of the water cooling device, it is determined whether the water drinking apparatus is in a water discharging state according to the rising reference time, the falling reference time, the rising reference adjustment value, and the falling reference adjustment value of each temperature point, and the actual rising time and the actual falling time of each temperature point. Therefore, the water drinking apparatus is able to determine the water discharging state of the water drinking apparatus without solenoid valve, thus decreasing the production cost of the water drinking apparatus and simplifying the structure of the water drinking apparatus.

In an embodiment of the present disclosure, the control module is configured to determine that the water drinking apparatus is in the water discharging state when an actual falling time of any temperature point is greater than a first preset multiple of a sum of a falling reference time and a falling reference adjustment value of the temperature point.

In an embodiment of the present disclosure, the control module is configured to determine that the water drinking apparatus is in the water discharging state when an actual falling time of each of three consecutive temperature points is greater than a sum of a falling reference time and a falling reference adjustment value of the each of the three consecutive temperature points.

In an embodiment of the present disclosure, the control module is configured to determine that the water drinking apparatus is in the water discharging state when an actual rising time of any temperature point is smaller than a second preset multiple of a difference between a rising reference time and a rising reference adjustment value of the temperature point.

In an embodiment of the present disclosure, the control module is configured to determine that the water drinking apparatus is in the water discharging state when an actual rising time of each of three consecutive temperature points is smaller than a difference between a rising reference time and a rising reference adjustment value of the each of the three consecutive temperature points.

In an embodiment of the present disclosure, the control module is configured to determine that the water drinking apparatus is in the water discharging state when the water temperature of the cooled water of the water cooling device is in a rising state and is increased by jump.

### BRIEF DESCRIPTION OF THE DRAWINGS

FIG. 1 is a flow chart of a method for detecting water discharge of a water drinking apparatus according to an embodiment of the present disclosure;

FIG. 2 is a flow chart of a method for detecting water discharge of a water drinking apparatus according to one embodiment of the present disclosure; and

FIG. 3 is a block diagram of a water drinking apparatus according to an embodiment of the present disclosure.

Reference numerals: water cooling device 101, temperature detector 102 and control module 103.

### DETAILED DESCRIPTION

Embodiments of the present disclosure are described in detail below, examples of which are illustrated in the drawings. The same or similar elements are denoted by same reference numerals in different drawings unless indicated otherwise. The embodiments described herein with reference to drawings are explanatory, and used to generally understand the present disclosure. The embodiments shall not be construed to limit the present disclosure.

A water drinking apparatus and a method for detecting a water discharging state of a water drinking apparatus provided by embodiments of the present disclosure are described below with reference to the drawings.

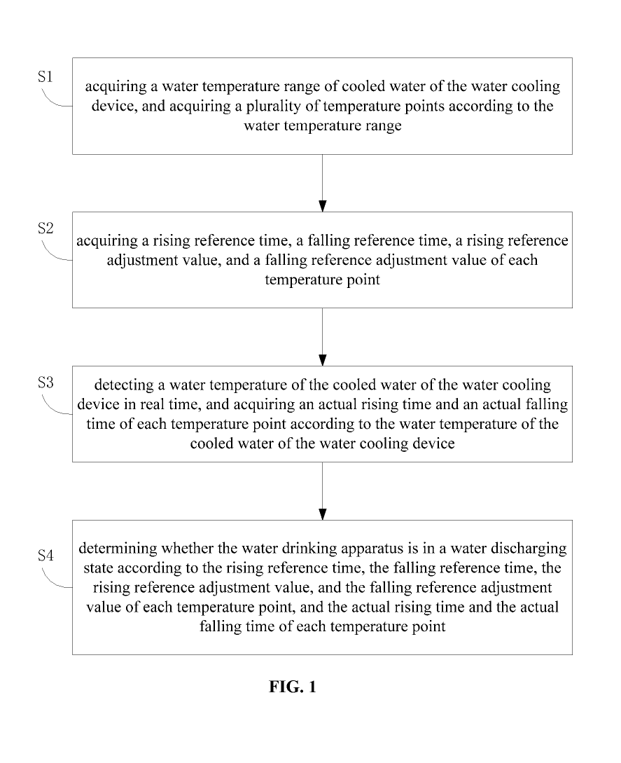

FIG. 1 is a flow chart of a method for detecting water discharge of a water drinking apparatus according to an embodiment of the present disclosure. As shown in FIG. 1, the method for detecting water discharge of the water drinking apparatus includes following steps.

At S1, a water temperature range of cooled water of the water cooling device is acquired, and a plurality of temperature points is acquired according to the water temperature range.

In an embodiment of the present disclosure, the water drinking apparatus includes a water cooling device and a cooled water mechanical faucet, and the water of the water drinking apparatus is cooled by the water cooling device and then flows out through the cooled water mechanical faucet. The water drinking apparatus further includes a temperature detector configured to detect the water temperature of the cooled water of the water cooling device, and the temperature detector may be disposed inside the water cooling device.

Specifically, firstly, the water temperature range [Tmin, Tmax] of the cooled water may be determined according to the refrigeration performance of the water cooling device, and after the water temperature range [Tmin, Tmax] is determined, a plurality of temperature points to be recorded can be determined, for example, every temperature point is recorded with an interval of 1° C., and the number of temperature points to be recorded in the water temperature range [Tmin, Tmax] is Tmax-Tmin.

At S2, a rising reference time, a falling reference time, a rising reference adjustment value, and a falling reference adjustment value of each temperature point are acquired.

Specifically, when the water drinking apparatus is powered on and a whole machine test is performed, the temperature of the cooled water of the water cooling device is detected by the temperature detector, and the rising time and the falling time of each temperature point are recorded. In other words, when the water temperature is increased, the rising time of each temperature point is recorded, and when the water temperature is decreased, the falling time of each temperature point is recorded. It should be noted that each temperature point has two adjacent temperature points, the rising time of a temperature point refers to the time when the temperature point is increased to a larger temperature point of two adjacent temperature points, and the falling time of a temperature point refers to the time when the temperature point is decreased to a smaller temperature point of the two adjacent temperature points. For example, there are three consecutive temperature points T1, T2 and T3, in which T1<T2<T3, such that the rising time of the temperature point T2 refers to the time when the temperature point T2 is increased to the temperature point T3, and the falling time of the temperature point T2 refers to the time when the temperature point T2 is decreased to the temperature point T1.

Therefore, the whole machine test is performed for N times to record N rising times and N falling times of the temperature points, N is a positive integer. A rising reference time, a falling reference time, a rising reference adjustment value and a falling reference adjustment value of each temperature point are acquired according to the N rising times and the N falling times of the temperature points. For example, according to the cooling test of the whole machine, the following set of values may be determined.

When the temperature is decreased, the falling reference times of a plurality of temperature points may be M0, M1, M2, . . . , respectively.

When the temperature is decreased, the falling reference adjustment values of a plurality of temperature points may be P0, P1, P2, . . . , respectively.

When the temperature is increased, the rising reference times of a plurality of temperature points may be N0, N1, N2, . . . , respectively.

When the temperature is increased, the rising reference adjustment values of a plurality of temperature points may be Q0, Q1, Q2, . . . , respectively.

It should be understood that the water drinking apparatus is not in a water discharging state during the whole machine test.

At S3, a water temperature of the cooled water of the water cooling device is detected in real time, and an actual rising time and an actual falling time of each temperature point are acquired according to the water temperature of the cooled water of the water cooling device.

Specifically, in the case that the water drinking apparatus is powered on and is working, when the water temperature is changed, the temperature of the cooled water of the water cooling device may be detected by the temperature detector in real time. During a process of decreasing the temperature, the actual falling time of each temperature point of the detected water temperatures is recorded, and during a process of increasing the temperature, the actual rising time of each temperature point of the detected water temperatures is recorded. For example, the actual falling times of a plurality of the temperature points may be recorded as m0, m1, m2, . . . , respectively, and the actual rising times of a plurality of the temperature points may be recorded as n0, n1, n2, . . . , respectively. It should be understood that when the cooled water in the water drinking apparatus is used by a user, the time required for the increase or decrease of the water temperature will be affected, resulting in a large difference between the actual rising time or the actual falling time and the corresponding time acquired in the test.

In addition, it should be noted that when the temperature is decreased, an actual falling time of a temperature point which is not detected in the water temperature range may be directly set as the falling reference time of the temperature point, and when the temperature is increased, an actual rising time of a temperature point which is not detected in the water temperature range may be directly set as the rising reference time of the temperature point.

At S4, it is determined whether the water drinking apparatus is in a water discharging state according to the rising reference time, the falling reference time, the rising reference adjustment value, and the falling reference adjustment value of each temperature point, and the actual rising time and the actual falling time of each temperature point.

Specifically, after the actual rising time and the actual falling time of each temperature point are acquired, an actual rising time of a temperature point may be compared with a rising reference time and a rising reference adjustment value of this temperature point to acquire a first comparison result, and an actual falling time of a temperature point may be compared with a falling reference time and a falling reference adjustment value of this temperature point to obtain a second comparison result. According to the first comparison result and the second comparison result, it may be determined that whether the water drinking apparatus is in the water discharging state.

In an embodiment of the present disclosure, determining whether the water drinking apparatus is in a water discharging state according to the rising reference time, the falling reference time, the rising reference adjustment value, and the falling reference adjustment value of each temperature point, and the actual rising time and the actual falling time of each temperature point includes:

determining whether an actual falling time of any temperature point is greater than a first preset multiple of a sum of a falling reference time and a falling reference adjustment value of the temperature point;

if yes, determining that the water drinking apparatus is in the water discharging state.

Specifically, the first preset multiple is constant and greater than or equal to 2.

Specifically, when the water drinking apparatus is working, an ith temperature point Ti is taken as an example, if an actual falling time mi of the temperature point Ti is greater than the first preset multiple K0 of the sum of the falling reference time Mi and the falling reference adjustment value Pi of the temperature point Ti, i.e., mi>(Mi+Pi)*K0, it is determined that the water drinking apparatus is in the water discharging state.

In other words, if there is a significant increase in the actual falling time of any temperature point compared to the time tested in the whole machine test, it indicates that there is heat exchange between the water in the water cooling device and external water (for example, water in a water tank of the water drinking apparatus). On this basis, it may be determined that the water drinking apparatus is in the water discharging state.

In an embodiment of the present disclosure, determining whether the water drinking apparatus is in a water discharging state according to the rising reference time, the falling reference time, the rising reference adjustment value, and the falling reference adjustment value of each temperature point, and the actual rising time and the actual falling time of each temperature point further includes:
determining whether an actual falling time of each of three consecutive temperature points is greater than a sum of a falling reference time and a falling reference adjustment value of the each of the three consecutive temperature points;
if yes, determining that the water drinking apparatus is in the water discharging state.

Specifically, when the water drinking apparatus is working, if there are three consecutive temperature points such as an ith temperature point Ti, an (i+1)th temperature point T(i+1) and the an i+2th temperature point T(i+2) meeting the following conditions: mi >(Mi+Pi), m(i+1) >[M(i+1)+P(i+1)] and m(i+2)>[M(i+2)+P(i+2)], it is determined that the water drinking apparatus is in the water discharging state.

In other words, when compared with the whole machine test, if the actual falling time of each of the three consecutive temperature points is greater than the sum of the falling reference time and the falling reference adjustment value of each of the three consecutive temperature points, it indicates that there is heat exchange between the water in the water cooling device and external water (for example, water in a water tank of the water drinking apparatus). On this basis, it may be determined that the water drinking apparatus is in the water discharging state.

In an embodiment of the present disclosure, determining whether the water drinking apparatus is in a water discharging state according to the rising reference time, the falling reference time, the rising reference adjustment value, and the falling reference adjustment value of each temperature point, and the actual rising time and the actual falling time of each temperature point further includes:
determining whether an actual rising time of any temperature point is smaller than a second preset multiple of a difference between a rising reference time and a rising reference adjustment value of the temperature point;
if yes, determining that the water drinking apparatus is in the water discharging state.

Specifically, the second preset multiple is constant and smaller than 1.

Specifically, when the water drinking apparatus is working, an ith temperature point Ti is taken as an example, if an actual rising time ni of the temperature point Ti is smaller the second preset multiple K1 of the difference between the rising reference time Ni and a rising reference adjustment value Qi of the temperature point Ti, i.e., ni<(Ni−Qi)*K1, it is determined that the water drinking apparatus is in the water discharging state.

In other words, if there is a significant decrease in the actual rising time of any temperature point compared to the time tested in the whole machine test, it indicates that there is heat exchange between the water in the water cooling device and external water (for example, water in a water tank of the water drinking apparatus). On this basis, it may be determined that the water drinking apparatus is in the water discharging state.

In an embodiment of the present disclosure, determining whether the water drinking apparatus is in a water discharging state according to the rising reference time, the falling reference time, the rising reference adjustment value, and the falling reference adjustment value of each temperature point, and the actual rising time and the actual falling time of each temperature point further includes:
determining whether an actual rising time of each of three consecutive temperature points is smaller than a difference between a rising reference time and a rising reference adjustment value of the each of the three consecutive temperature points;
if yes, determining that the water drinking apparatus is in the water discharging state.

Specifically, when the water drinking apparatus is working, if there are three consecutive temperature points such as an ith temperature point Ti, an i+1th temperature point T(i+1) and the an (i+2)th temperature point T(i+2) meeting the following conditions: ni <(Ni−Qi), n(i+1)<[N(i+1)−Q(i+1)] and n(i+2)<[N(i+2)−Q(i+2)], it is determined that the water drinking apparatus is in the water discharging state.

In other words, when compared with the whole machine test, if the actual rising time of each of the three consecutive temperature points is smaller than the difference between the rising reference time and the rising reference adjustment value of the each of the three consecutive temperature points, it indicates that there is heat exchange between the water in the water cooling device and external water (for example, water in a water tank of the water drinking apparatus). On this basis, it may be determined that the water drinking apparatus is in the water discharging state.

In addition, in an embodiment of the present disclosure, it is determined that the water drinking apparatus is in the water discharging state when the water temperature of the cooled water of the water cooling device is in a rising state and is increased by jump.

Specifically, when the water drinking apparatus is working, if the temperature is increased from a certain temperature point to another temperature point by jump, for example, from an ith temperature point to an i+3th temperature point, it indicates that there is heat exchange between the water in the water cooling device and external water (for example, water in a water tank of the water drinking apparatus), resulting in an inconsecutive temperature change. On this basis, it may be determined that the water drinking apparatus is in the water discharging state.

In addition, if it is determined that none of the rising reference time, the falling reference time, the rising reference adjustment value and the falling reference adjustment value, and the actual rising time and the actual falling time detected in real time of each temperature point satisfies the above conditions, it indicates that the water drinking apparatus is not in the water discharging state.

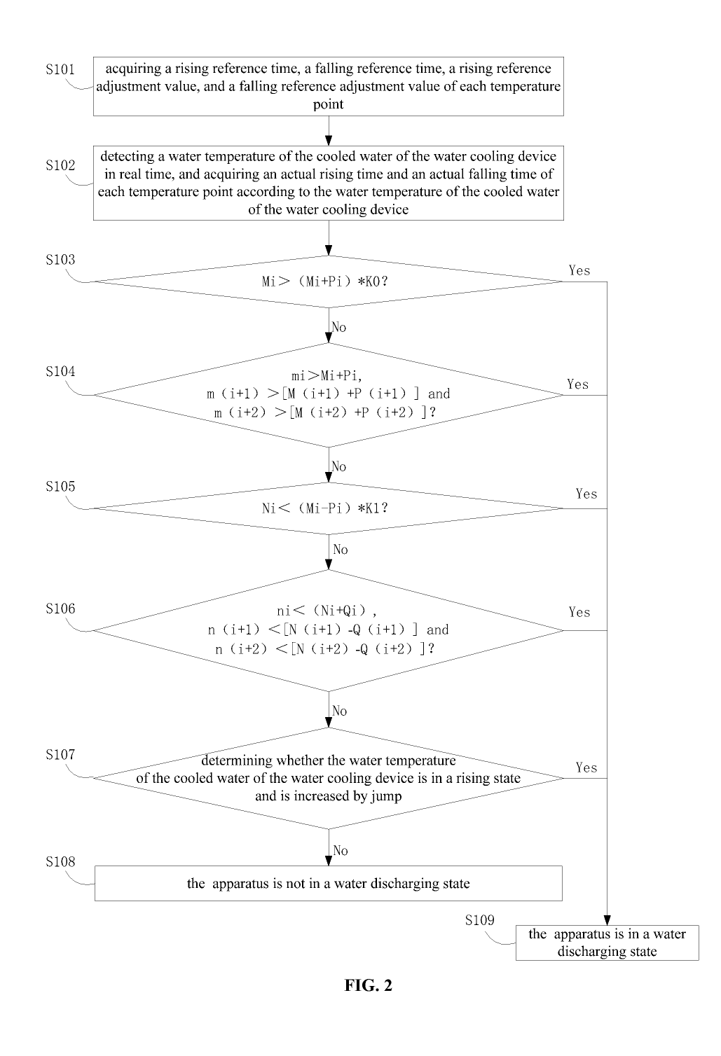

As described above, according to an embodiment of the present disclosure, as shown in FIG. 2, the method for detecting water discharge of a water drinking apparatus may include the following steps.

S101: acquiring a rising reference time, a falling reference time, a rising reference adjustment value, and a falling reference adjustment value of each temperature point.

S102: detecting a water temperature of the cooled water of the water cooling device in real time, and acquiring an actual rising time and an actual falling time of each temperature point according to the water temperature of the cooled water of the water cooling device.

S103: determining whether an actual falling time mi of an ith temperature point Ti is greater than a first preset multiple K0 of a sum of a falling reference time Mi and a falling reference adjustment value Pi of the temperature point Ti;

if yes, performing S109; if no, performing S104.

S104: determining whether an actual falling time mi, m(i+1) or m(i+2) of each of three consecutive temperature points is greater than a sum of a falling reference time Mi, M(i+1) or M(i+2) and a falling reference adjustment value Pi, P(i+1) or P(i+2) of the each of the three consecutive temperature points;

if yes, performing S109; if no, performing S105.

S105: determining whether an actual rising time ni of an ith temperature point Ti is smaller than a second preset multiple K1 of a difference between a rising reference time Ni and a rising reference adjustment value Qi of the temperature point;

if yes, performing S109; if no, performing S106.

S106: determining whether an actual rising time ni, n(i+1) or n(i+2) of each of three consecutive temperature points is smaller than a difference between a rising reference time Ni, N(i+1) or N(i+2) and a rising reference adjustment value Qi, Q(i+1) or Q(i+2) of the each of the three consecutive temperature points

if yes, performing S109; if no, performing S107.

S107: determining whether the water temperature of the cooled water of the water cooling device is in a rising state and is increased by jump;

if yes, performing S109; if no, performing S108.

S108: determining that the water drinking apparatus is not in a water discharging state.

S109: determining that the water drinking apparatus is in a water discharging state.

It should be noted that, during the actual working process of the water drinking apparatus, when the water drinking apparatus is not in the water discharging state, M rising and falling periods are cycled continuously. If an absolute value of the difference between the actual rising time and the rising reference time of each temperature point is smaller than the rising reference adjustment value, and an absolute value of the difference between the actual falling time and the falling reference time of each temperature point is smaller than the falling reference adjustment value, an average value of the M actual rising times or M actual falling times of each temperature point is calculated, and further used as an updated rising reference time or falling reference time of the temperature point, in which M may be 3.

In addition, in an embodiment of the present disclosure, when it is determined whether the water drinking apparatus is in the water discharging state, a display device of the water drinking apparatus may be controlled to display to present a state prompt to the user. Alternatively, when it is determined whether the water drinking apparatus is in the water discharging state, the water drinking apparatus is configured to perform a cooling control according to a preset control program.

In conclusion, with the method for detecting water discharge of a water drinking apparatus provided by embodiments of the present disclosure, the water temperature of the cooled water of the water cooling device is detected in real time, and the actual rising time and the actual falling time of each temperature point are acquired according to the water temperature of the cooled water of the water cooling device, it is determined whether the water drinking apparatus is in a water discharging state according to the rising reference time, the falling reference time, the rising reference adjustment value, and the falling reference adjustment value of each temperature point, and the actual rising time and the actual falling time of each temperature point. Therefore, the method may be applied to determine the water discharging state of the water drinking apparatus without solenoid valve, thus decreasing the production cost of the water drinking apparatus and simplifying the structure of the water drinking apparatus.

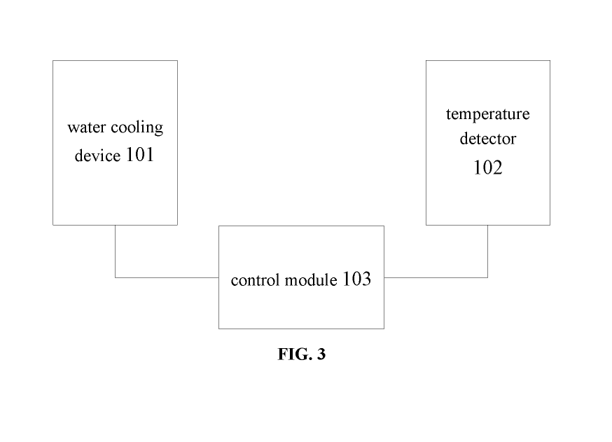

FIG. 3 is a block diagram of a water drinking apparatus according to an embodiment of the present disclosure. As shown in FIG. 3, the water drinking apparatus includes: a water cooling device 101, a temperature detector 102 and a control module 103.

Specifically, the water cooling device 101 is configured to cool water, and the water of the water drinking apparatus is cooled by the water cooling device 101 and then flows out through the cooled water mechanical faucet. The temperature detector 102 is configured to detect a water temperature of cooled water of the water cooling device and may be disposed inside the water cooling device 101. The control module 103 is coupled to the water cooling device 101 and the temperature detector 102, respectively. Specifically, after the water drinking apparatus is powered on, the control module 103 is configured to control the water cooling device 101 to cool the water down, and the temperature detector 102 is configured to transmit the water temperatures detected in real time to the control module 103, and the control module 103 is configured to store and process the received water temperature data.

The control module 103 is configured to acquire a water temperature range of the cooled water of the water cooling device, and acquire a plurality of temperature points according to the water temperature range and acquire a rising reference time, a falling reference time, a rising reference adjustment value, and a falling reference adjustment value of each temperature point. Specifically, during operation of the water cooling device, the control module 103 is further configured to acquire an actual rising time and an actual falling time of each temperature point according to the water temperature of the cooled water of the water cooling device 101 and determine whether the water drinking apparatus is in a water discharging state according to the rising reference time, the falling reference time, the rising reference adjustment value and the falling reference adjustment value of each temperature point, and the actual rising time and the actual falling time of each temperature point.

Specifically, the water temperature range [Tmin, Tmax] of the cooled water may be determined according to the refrigeration performance of the water cooling device, and after the water temperature range [Tmin, Tmax] is determined, a plurality of temperature points to be recorded can be determined, for example, every temperature point is recorded with an interval of 1° C., and the number of temperature points to be recorded in the water temperature range [Tmin, Tmax] is Tmax-Tmin.

The water drinking apparatus is powered on and a whole machine test is performed. In this case, when the water cooling device 101 starts to work, the temperature detector 102 is configured to detect the temperature of the cooled water of the water cooling device 101, and the control module 103 is configured to record the rising time and the falling time of each temperature point. In other words, when the water temperature is increased, the rising time of each temperature point is recorded by the control module 103, and when the water temperature is decreased, the falling time of each temperature point is recorded by the control module 103. It should be noted that each temperature point has two adjacent temperature points, the rising time of a temperature point refers to the time when the temperature point is increased to a larger temperature point of two adjacent temperature points, and the falling time of a temperature point refers to the time when the temperature point is decreased to a smaller temperature point of the two adjacent temperature points. For example, there are three consecutive temperature points T1, T2 and T3, in which T1<T2<T3, such that the rising time of the temperature point T2 refers to the time when the temperature point T2 is increased to the temperature point T3, and the falling time of the temperature point T2 refers to the time when the temperature point T2 is decreased to the temperature point T1.

Therefore, the whole machine test is performed for N times to record N rising times and N falling times of the temperature points, N is a positive integer. The control module 103 is configured to acquire a rising reference time, a falling reference time, a rising reference adjustment value and a falling reference adjustment value of each temperature point according to the N rising times and the N falling times of the temperature points. For example, according to the cooling test of the whole machine, the control module 103 is configured to determine the following set of values.

When the temperature is decreased, the falling reference times of a plurality of temperature points may be M0, M1, M2, . . . , respectively.

When the temperature is decreased, the falling reference adjustment values of a plurality of temperature points may be P0, P1, P2, . . . , respectively.

When the temperature is increased, the rising reference times of a plurality of temperature points may be N0, N1, N2, . . . , respectively.

When the temperature is increased, the rising reference adjustment values of a plurality of temperature points may be Q0, Q1, Q2, . . . , respectively.

It should be understood that the water drinking apparatus is not in the water discharging state during the whole machine test.

Further, in the case that the water drinking apparatus is powered on and is working, when the water temperature is changed, the temperature of the cooled water of the water cooling device 101 may be detected by the temperature detector 102 in real time. During a process of decreasing the temperature, the control module 103 is configured to record the actual falling time of each temperature point of the detected water temperatures, and during a process of increasing the temperature, the control module 103 is configured to record the actual rising time of each temperature point of the detected water temperatures. For example, the actual falling times of a plurality of the temperature points may be recorded as m0, m1, m2, . . . , respectively, and the actual rising times of a plurality of the temperature points may be recorded as n0, n1, n2, . . . , respectively.

In this case, after the actual rising time and the actual falling time of each temperature point are acquired by the control module 103, an actual rising time of a temperature point may be compared with a rising reference time and a rising reference adjustment value of this temperature point to acquire a first comparison result, and an actual falling time of a temperature point may be compared with a falling reference time and a falling reference adjustment value of this temperature point to obtain a second comparison result. According to the first comparison result and the second comparison result, it may be determined that whether the water drinking apparatus is in the water discharging state.

In an embodiment of the present disclosure, the control module 103 is configured to determine that the water drinking apparatus is in the water discharging state when an actual falling time of any temperature point is greater than a first preset multiple of a sum of a falling reference time and a falling reference adjustment value of the temperature point.

Specifically, when the water drinking apparatus is working, the control module 103 is configured to analyze and process the water temperature data. If an actual falling time mi of an ith temperature point Ti is greater than the first preset multiple KO of the sum of the falling reference time Mi and the falling reference adjustment value Pi of the temperature point Ti, i.e., mi>(Mi+Pi)*K0, it is determined by the control module 103 that the water drinking apparatus is in the water discharging state.

In other words, if there is a significant increase in the actual falling time of any temperature point compared to the time tested in the whole machine test, it indicates that there is heat exchange between the water in the water cooling device 101 and external water (for example, water in a water tank of the water drinking apparatus). On this basis, it may be determined by the control module 103 that the water drinking apparatus is in the water discharging state.

In an embodiment of the present disclosure, the control module 103 is configured to determine that the water drinking apparatus is in the water discharging state when an actual falling time mi, m(i+1) or m(i+2) of each of three consecutive temperature points is greater than a sum of a falling reference time Mi, M(i+1) or M(i+2) and a falling reference adjustment value Pi, P(i+1) or P(i+2) of the each of the three consecutive temperature points.

Specifically, when the water drinking apparatus is working, if there are three consecutive temperature points such as an ith temperature point Ti, an i+1th temperature point T(i+1) and the an i+2th temperature point T(i+2) meeting the following conditions: mi >(Mi+Pi), m(i+1)>[M(i+1)+P(i+1)] and m(i+2)>[M(i+2)+P(i+2)], it is determined by the control module 103 that the water drinking apparatus is in the water discharging state.

In other words, when compared with the whole machine test, if the actual falling time of each of the three consecutive temperature points is greater than the sum of the falling reference time and the falling reference adjustment value of each of the three consecutive temperature points, it indicates that there is heat exchange between the water in the water cooling device 101 and external water (for example, water in a water tank of the water drinking apparatus). On this basis, it may be determined by the control module 103 that the water drinking apparatus is in the water discharging state.

In an embodiment of the present disclosure, the control module 103 is configured to determine that the water drinking apparatus is in the water discharging state when an actual rising time ni of any temperature point is smaller than a second preset multiple K1 of a difference between a rising reference time Ni and a rising reference adjustment value Qi of the temperature point.

Specifically, when the water drinking apparatus is working, the control module 103 is configured to analyze and process the water temperature data. If an actual rising time ni of an ith temperature point Ti is smaller the second preset multiple K1 of the difference between the rising reference time Ni and a rising reference adjustment value Qi of the temperature point Ti, i.e., ni<(Ni−Qi)*K1, it is determined by the control module 103 that the water drinking apparatus is in the water discharging state.

In other words, if there is a significant decrease in the actual rising time of any temperature point compared to the time tested in the whole machine test, it indicates that there is heat exchange between the water in the water cooling device 101 and external water (for example, water in a water tank of the water drinking apparatus). On this basis, it may be determined by the control module 103 that the water drinking apparatus is in the water discharging state.

In an embodiment of the present disclosure, the control module 103 is configured to determine that the water drinking apparatus is in the water discharging state when an actual rising time ni, n(i+1) or n(i+2) of each of three consecutive temperature points is smaller than a difference between a rising reference time Ni, N(i+1) or N(i+2) and a rising reference adjustment value Qi, Q(i+1) or Q(i+2) of the each of the three consecutive temperature points.

Specifically, when the water drinking apparatus is working, the control module 103 is configured to analyze and process the water temperature data. If there are three consecutive temperature points such as an ith temperature point Ti, an i+1th temperature point T(i+1) and the an i+2th temperature point T(i+2) meeting the following conditions: ni<(Ni−Qi), n(i+1)<[N(i+1)−Q(i+1)] and n(i+2)<[N(i+2)−Q(i+2)], it is determined by the control module 103 that the water drinking apparatus is in the water discharging state.

In other words, when compared with the whole machine test, if the actual rising time of each of the three consecutive temperature points is smaller than the difference between the rising reference time and the rising reference adjustment value of the each of the three consecutive temperature points, it indicates that there is heat exchange between the water in the water cooling device 101 and external water (for example, water in a water tank of the water drinking apparatus). On this basis, it may be determined by the control module 103 that the water drinking apparatus is in the water discharging state.

In an embodiment of the present disclosure, the control module 103 is configured to determine that the water drinking apparatus is in the water discharging state when the water temperature of the cooled water of the water cooling device 101 is in a rising state and is increased by jump.

Specifically, when the water drinking apparatus is working, if the control module 103 is configured to acquire that the temperature is increased from a certain temperature point to another temperature point by jump, it indicates that there is heat exchange between the water in the water cooling device 101 and external water (for example, water in a water tank of the water drinking apparatus), resulting in an inconsecutive temperature change. On this basis, it may be determined by the control module 103 that the water drinking apparatus is in the water discharging state.

In conclusion, with the water drinking apparatus provided by embodiments of the present disclosure, the water temperature of the cooled water of the water cooling device is detected in real time by the temperature detector, and the actual rising time and the actual falling time of each temperature point are acquired by the control module according to the water temperature of the cooled water of the water cooling device, it is determined by the control module whether the water drinking apparatus is in a water discharging state according to the rising reference time, the falling reference time, the rising reference adjustment value, and the falling reference adjustment value of each temperature point, and the actual rising time and the actual falling time of each temperature point. Therefore, the water drinking apparatus is able to determine the water discharging state of the water drinking apparatus without solenoid valve, thus decreasing the production cost of the water drinking apparatus and simplifying the structure of the water drinking apparatus.

In the specification, it is to be understood that terms such as “central”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial direction”, “radial direction” and “circumferential direction” should be construed to refer to the orientation as then described or as shown in the drawings under discussion. These relative terms are for convenience of description and do not require that the present invention be constructed or operated in a particular orientation, and thus shall not be construed to limit the present disclosure.

In addition, it should be understood that terms such as “first” and “second” are used herein for purposes of description and are not intended to indicate or imply relative importance or significance or to imply the number of indicated technical features. Therefore, the feature defined with “first” and “second” may include one or more of this feature. In the description of the present disclosure, unless specified otherwise, “a plurality of” means at least two, such as two or three.

In the present disclosure, unless specified or limited otherwise, the terms “mounted”, “connected”, “coupled”, “fixed” and the like are used broadly, and may be, for example, fixed connections, detachable connections, or integral connections; may also be mechanical or electrical connections; may also be direct connections or indirect connections via intervening structures; may also be inner communications or inner interactions of two elements. Specific meanings of the above terms in the present disclosure can be understood by those skilled in the art on a case-by-case basis.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above”, or “on top” of a second feature may include an embodiment in which the first feature is right or obliquely “on”, “above”, or “on top of” the second feature, or just means that the first feature is at a height higher than that of the second feature; while a first feature “below”, “under”, or “on bottom of” a second feature may include an embodiment in which the first feature is right or obliquely “below”, “under”, or “on bottom of” the second feature, or just means that the first feature is at a height lower than that of the second feature.

Reference throughout this specification to “an embodiment”, “some embodiments”, “an example”, “a specific example”, or “some examples” means that a particular feature, structure, material, or characteristic described in connection with the embodiment or example is included in at least one embodiment or example of the present disclosure. The appearances of above phrases in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples described in the specification, as well as features of embodiments or examples, without conflicting, may be combined by one skilled in the art.

Although explanatory embodiments have been shown and described above, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for detecting water discharge of a water drinking apparatus, wherein the water drinking apparatus comprises a water cooling device and a temperature detector, the method comprises:
acquiring a water temperature range of cooled water of the water cooling device, and acquiring a plurality of temperature points within the water temperature range;
for each temperature point, acquiring a rising reference time, a falling reference time, a rising reference adjustment value, and a falling reference adjustment value of the temperature point;
detecting, using the temperature detector, a water temperature of the cooled water of the water cooling device in real time, and acquiring an actual rising time and an actual falling time of each temperature point according to the water temperature of the cooled water of the water cooling device; and
determining whether the water drinking apparatus is in a water discharging state according to the rising reference time, the falling reference time, the rising reference adjustment value, and the falling reference adjustment value of each temperature point, and the actual rising time and the actual falling time of each temperature point.

2. The method for detecting water discharge of the water drinking apparatus according to claim 1, wherein determining whether the water drinking apparatus is in a water discharging state according to the rising reference time, the falling reference time, the rising reference adjustment value, and the falling reference adjustment value of each temperature point, and the actual rising time and the actual falling time of each temperature point comprises:
determining whether an actual falling time of any temperature point is greater than a first preset multiple of a sum of a falling reference time and a falling reference adjustment value of the temperature point; and
if yes, determining that the water drinking apparatus is in the water discharging state.

3. The method for detecting water discharge of the water drinking apparatus according to claim 1, wherein determining whether the water drinking apparatus is in a water discharging state according to the rising reference time, the falling reference time, the rising reference adjustment value, and the falling reference adjustment value of each temperature point, and the actual rising time and the actual falling time of each temperature point further comprises:
determining whether an actual falling time of each of three consecutive temperature points is greater than a sum of a falling reference time and a falling reference adjustment value of the each of the three consecutive temperature points; and
if yes, determining that the water drinking apparatus is in the water discharging state.

4. The method for detecting water discharge of the water drinking apparatus according to claim 1, wherein determining whether the water drinking apparatus is in a water discharging state according to the rising reference time, the falling reference time, the rising reference adjustment value, and the falling reference adjustment value of each temperature point, and the actual rising time and the actual falling time of each temperature point further comprises:
determining whether an actual rising time of any temperature point is smaller than a second preset multiple of a difference between a rising reference time and a rising reference adjustment value of the temperature point; and
if yes, determining that the water drinking apparatus is in the water discharging state.

5. The method for detecting water discharge of the water drinking apparatus according to claim 1, wherein determining whether the water drinking apparatus is in a water discharging state according to the rising reference time, the falling reference time, the rising reference adjustment value, and the falling reference adjustment value of each temperature point, and the actual rising time and the actual falling time of each temperature point further comprises:
determining whether an actual rising time of each of three consecutive temperature points is smaller than a difference between a rising reference time and a rising reference adjustment value of the each of the three consecutive temperature points; and
if yes, determining that the water drinking apparatus is in the water discharging state.

6. The method for detecting water discharge of the water drinking apparatus according to claim 1, wherein it is determined that the water drinking apparatus is in the water discharging state when the water temperature of the cooled water of the water cooling device is in a rising state and is increased by jump.

7. A water drinking apparatus, comprising:
a water cooling device, configured to cool water;
a temperature detector, configured to detect a water temperature of cooled water of the water cooling device; and
a control module, configured to acquire a water temperature range of the cooled water of the water cooling device, and acquire a plurality of temperature points within the water temperature range and, for each of the plurality of temperature points, acquire a rising reference time, a falling reference time, a rising reference adjustment value, and a falling reference adjustment value of the temperature point, wherein
during operation of the water cooling device, the control module is further configured to:
acquire an actual rising time and an actual falling time of each temperature point according to the water temperature of the cooled water of the water cooling device; and
determine whether the water drinking apparatus is in a water discharging state according to the rising reference time, the falling reference time, the rising reference adjustment value and the falling reference adjustment value of each temperature point, and the actual rising time and the actual falling time of each temperature point.

8. The water drinking apparatus according to claim 7, wherein the control module is configured to determine that the water drinking apparatus is in the water discharging state when an actual falling time of any temperature point is greater than a first preset multiple of a sum of a falling reference time and a falling reference adjustment value of the temperature point.

9. The water drinking apparatus according to claim 7, wherein the control module is configured to determine that the water drinking apparatus is in the water discharging state when an actual falling time of each of three consecutive temperature points is greater than a sum of a falling reference time and a falling reference adjustment value of the each of the three consecutive temperature points.

10. The water drinking apparatus according to claim 7, wherein the control module is configured to determine that the water drinking apparatus is in the water discharging state when an actual rising time of any temperature point is smaller than a second preset multiple of a difference between a rising reference time and a rising reference adjustment value of the temperature point.

11. The water drinking apparatus according to claim 7, wherein the control module is configured to determine that the water drinking apparatus is in the water discharging state when an actual rising time of each of three consecutive temperature points is smaller than a difference between a rising reference time and a rising reference adjustment value of the each of the three consecutive temperature points.

12. The water drinking apparatus according to claim 7, wherein the control module is configured to determine that the water drinking apparatus is in the water discharging state when the water temperature of the cooled water of the water cooling device is in a rising state and is increased by jump.
